(19) United States
(12) Patent Application Publication
(10) Pub. No.: US 2010/0299119 A1
(43) Pub. Date: Nov. 25, 2010

(54) PERFORMANCE MONITOR FOR SUBSEA EQUIPMENT

(75) Inventors: Klas Goran Erikson, Asker (NO); Hallgeir Melbo, Bekkestua (NO)

Correspondence Address: Vern Maine & Associates, 547 AMHERST STREET, 3RD FLOOR, NASHUA, NH, 03063-4000, US

(73) Assignee: AKER SUBSEA AS, Lysaker (NO)

(21) Appl. No.: 12/446,282

(22) PCT Filed: Oct. 19, 2007
(86) PCT No.: PCT/NO07/00371

§ 371 Date: May 10, 2010

(30) Foreign Application Priority Data
Oct. 20, 2006 (NO) 2006 4749

(51) Int. Cl. G06G 7/48; G06F 15/00

(52) U.S. Cl. 703/6; 702/184

(57) ABSTRACT

The present invention relates to a system and method for monitoring subsea equipment performance and for providing early warning for equipment maintenance, comprising at least one sensor coupled to said equipment and arranged to measure at least one performance indicator value and a calculation unit for sampling the measured indicator values at a chosen rate, and from the sampled data estimating a likely future development of the sampled value and estimating the time for the passing of a chosen threshold value, the threshold value being a critical value requiring repair of replacements of said equipment, the system being adapted to provide a signal indicating the calculated time of repair/replacement.

This invention relates to a system for monitoring the performance of subsea equipment e.g. in relation to oil/gas installations.

In oil/gas installations there are several units positioned at the sea floor or downhole in oil or gas wells, performing necessary tasks in order to control the production or to transport the hydrocarbons from the well to the sea surface or to land. Many of these units contain equipment being subject to wear and thus have to be repaired or replaced from time to time. These intervals depend on use and the conditions on location, and are therefore difficult to predict. The result is an occasional emergency stop in the production.

Repairs performed on subsea equipment requires preparations of boats, ROVs, or divers, in addition to the parts that has to be repaired or replaced. This leads to long downtime periods related to unpredicted stops, and thus large costs related to each breakdown in the subsea parts. For a typical field, the production gain from having a pump running is in the order of 0.5 M$/day (2006 values), so that a 2 week extra downtime translates into 7 M$ or so.

A known system for time to failure prediction is discussed in U.S. Pat. No. 6,834,256, where a statistical model is made for the equipment based on the known the strains it is our has been subject to. The model requires conditional probabilities and is updated by measurements performed on the system. A problem related to this solution in subsea environment is that each situation is unique, and it is impossible to make valid models for each situation. Also, the solution described in U.S. Pat. No. 6,834,256 requires extensive calculations and measurements which may not be available on a subsea system.

Thus it is an object of this invention to provide a system which enables the operator to reduce the downtime of subsea equipment such as pumps. This is obtained as described in the accompanying claims.

The present invention thus relates to the prediction of the development by extrapolation based on chosen geometrical shapes of the future development of the relevant indices or on a known/assumed time development for each index, for example assuming that leaks through seals have a linear increase during the pump lifetime.

For many devices (in particular for a subsea pump) one may calculate one or more performance indices. When plotting these versus time, and setting a “tolerance” limit, one can then estimate the remaining time until service is required. The tolerance limit is chosen according to the indices and the nature of the equipment with a tolerance for errors and sudden changes in the system. As mentioned above being able to predict in advance when a subsea intervention is required leads to large cost savings, mainly in minimising downtime and also production loss.

A planned stop means that spare parts, personnel and installation vessels can be mobilised in an orderly manner. The subsea plant can continue operating until the intervention vessel is on site, thereby minimising the production downtime. If we compare this with an unplanned shutdown (where the pump suddenly malfunctions), the production loss will be greater as it takes time to prepare parts, vessel and personnel. The difference can be in the order of weeks, e.g. 24 hours downtime for a planned intervention versus several weeks for an unplanned intervention.

While other systems for prediction of residual life times for equipment are per se known, e.g. as disclosed in WO03/014851, the nature of the subsea equipment is such that the possibility for the diagnosis described therein is limited. Also the method in the abovementioned patent publication is based mainly on the detection of abnormal conditions. In subsea system there would be a risk that this moment would be too late, and thus the present invention is based on the monitoring and evaluation of the natural wear on the equipment.

The invention will be described more in detail below with reference to the accompanying drawings, illustrating the invention by way of example.

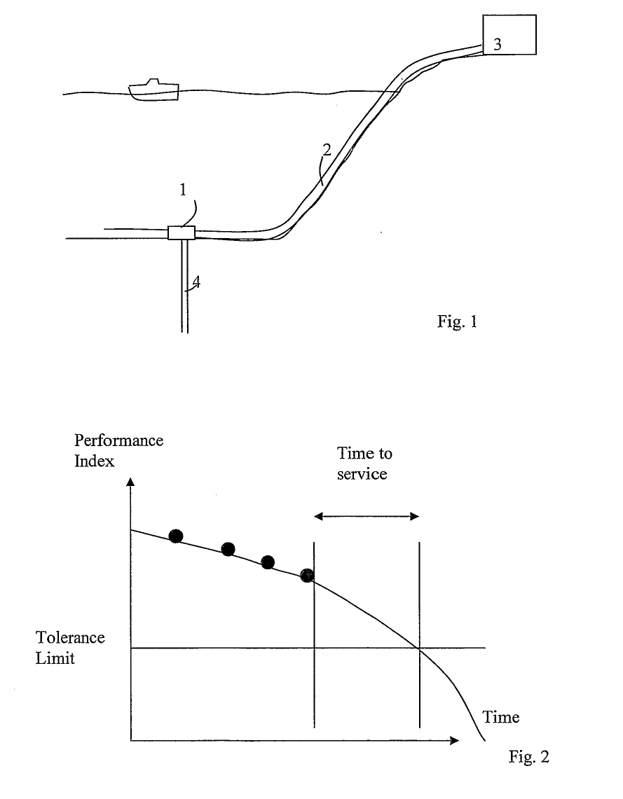

FIG. 1 illustrates schematically the system comprising a subsea unit.

FIG. 2 illustrates the performance index curve for predicting the performance of a unit.

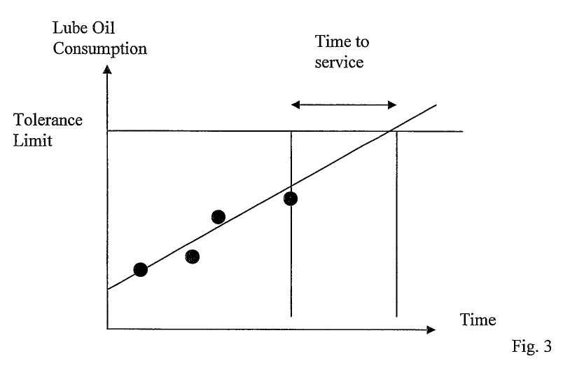

FIG. 3 illustrates a use of the invention where the lubrication oil consumption is used as a parameter.

FIG. 1 illustrates a system comprising a subsea installation 1 with a pipe or umbilical 2 to an onshore facility 3. The subsea installation 1 may, according to a preferred embodiment of the invention, incorporate a pump for transporting fluids through the pipe 2, e.g. to shore.

As is disclosed above the invention relates to the monitoring of the subsea installations 1 in order to avoid sudden halts in the operation and to provide planned maintenance, such as replacements or repairs before a critical situation occurs. This is done by measuring one or more values that are used to compute chosen indices indicating the status of the subsea equipment. The measurements and/or the indices are then transmitted for example along the pipeline or umbilical 2, to a monitoring instrument which includes a calculating unit being adopted to extrapolate to find the most likely development of the indices and to predict when the values will meet a predetermined threshold or tolerance limit which is defined as the limit for the indices, and through this calculate a time to service value. Thus the maintenance may be performed before the subsea device stops operating.

Now referring to FIG. 2. For many devices, in particular for a subsea pump, one may calculate one or more performance indices. When plotting these versus time, and setting a “tolerance” limit, one can then estimate the remaining time until service is required so that unnecessary stops are avoided and the maintenance costs are reduced. In FIG. 2 we see how a performance index has been plotted versus time. A curve has been fitted to the index values, which are based on the measured data, to estimate future degradation in performance. By setting a “tolerance limit” one can thus estimate the remaining time until service is required.

Possible performance indices related to subsea pumps replacement are in particular:
Lube oil consumption, when it exceeds a certain limit, dictated by e.g. umbilical capacity, pump replacement is required.
Pump efficiency, when it drops below a certain value, pump replacement is required)
Subsea accumulator bank capacity, when this drops below a certain value, replacement is required)
Motor temperature analysis, e.g. to ensure that a pump motor is not over heated.
PVR—performance analysis, e.g. monitoring the pressure in a pump motor.
Vibration analysis, e.g. of a pump motor.

### Lube Oil Consumption

The subsea pump containing a gearbox and coupling chamber, and the HV motor driving the pump, are filled with a dielectric fluid which also serves as a lubricant for the gearbox. The pressure of this lube oil is regulated such that any leaks will be from the lube oil filled volume into the process.

Leaks occur along the shaft connecting the motor to the pump, and the leaked oil goes into the process lines (pump discharge line). Leakage path is through bearings and seals. The bearings and seals slowly wear with time resulting in that the leakage paths slowly get larger and the leakage flow increases.

The fluid used as lube oil has a high viscosity at seabed temperatures, and is thus difficult to push through long umbilicals. Typically, a 100 bar driving pressure will produce a flow of 10 L/h in a 30 km long 12 mm umbilical line. If the leakage flow approaches the umbilical capacity, it is no longer possible to replenish lube oil at the same rate as it is leaking, and pump replacement becomes necessary.

The time dependency of the lube oil consumption is anticipated to be a linear function based on the following consideration (also confirmed with operating experience):
The size of the leakage path increases linearly with time (as material is being ground off from the bearing faces)
The flow through a restriction is linearly related to the size of the restriction
The flow is thus expected to grow linearly over time (all other things held equal)

When plotting lube oil consumption versus time, one should thus attempt to fit a straight line through the data as is illustrated in FIG. 3.

### Pump Efficiency

For any pump, a certain power at a certain speed is expected to generate a certain head. As the pump wears, it's ability to generate this head diminishes over time. Losses in bearings also increase over time, such that by monitoring how much of the applied power is being converted into mechanical work on the pumped fluid, the health of the pump can be monitored.

For any pump, the work done by the pump is

W=k1*Flow*Head (1)

with
W=Work (e.g. in kW),
Flow=Mass flow (e.g. kg/s),
Head=Pressure increase over pump (e.g. Bar)
k1=constant (depending on units of measurement and on the fluid density.

The head is typically measured using pressure sensors mounted on the pump. The mass flow is speed dependent (providing density of fluid is constant), i.e.

Flow=k2*Speed (2)

Combining (1) and (2) we get

W=k3*Speed*Head (3)

The power P_{shaft} applied to the pump (shaft power) comes in our case from the output shaft of a subsea HV motor.

This is being fed from topside via an umbilical, typically from a Variable Speed Drive (VSD). There are power losses through the VSD, through the umbilical, and in the HV motor itself.

We measure the power output from the VSD, and the characteristics of the umbilical are well known. We can thus calculate the power applied to the motor terminals from motor data, we know the relation between the power applied to the motor terminals, and the shaft power generated.

P_{shaft}=Effₘₒₜₒᵣ*Pmotorᵢₙ (4)

where
Effₘₒₜₒᵣ=efficiency of HV motor
Pmotorᵢₙ=Power applied to motor terminals

The relation between power applied to the motor and the power output from the VSD can be expressed as

Pmotorᵢₙ=eff_{umb}*PVSDₒᵤₜ (5)

where
eff_{umb}=efficiency of umbilical (calculated from current and frequency)
PVSDₒᵤₜ=Output power from VSD (measured)

Combining (4) and (5) we get

P_{shaft}=Effₘₒₜₒᵣ*eff_{umb}*PVSDₒᵤₜ (6)

We can thus calculate the power applied to the pump (form VSD output power, VSD frequency, umbilical data and motor data).

We can calculate the work done by the pump (from (1) above).

We can calculate the shaft power into the pump from (6) above.

The efficiency of the pump is given as Work done/Power applied, or

Effpump=(k3*Speed*Head)/(Effₘₒₜₒᵣ*Eff_{umb}*PVSDₒᵤₜ) (7)

Equation (7) is used if we have measurements for head, speed and VSD output power available. It is correct if fluid density is constant (while in practice it is often varying).

If further information is available e.g. regarding fluid density, then the constant k3 in (7) can be adjusted correspondingly, giving a better estimation of pump efficiency.

### Subsea Accumulator Bank Capacity

In the particular type of subsea pumping system addressed here, an accumulator bank of a multitude of accumulators is used to maintain overpressure in the subsea pump during cool-down. In one typical implementation 8 off 20 liter accumulators were used.

If e.g. the topside plant is suddenly shutdown, the subsea pump stops and gradually cool down. The dielectric oil inside the motor contracts and a lube oil supply is thus needed in order to maintain the slight overpressure. The overpressure is controlled via a mechanical regulator.

The lube oil accumulator bank contains sufficient volume to be able to supply all oil needed for a complete cooldown under worst case condition. There is also some additional capacity such that if a few accumulators fail, the size of the bank will still be sufficient.

Over time, the accumulators will stop working one by one. When e.g. 3 have stopped working, the accumulator bank can no longer maintain the overpressure in worst case conditions, and a pump module change-out should then be contemplated. The number of faulty accumulators is thus an important performance indicator.

The actual detection of how many accumulators are operational is the topic for the simultaneously filed Norwegian patent application No. 20064750 and the corresponding PCT application, which are incorporated here by way of reference. The important issue for the present invention is that the number of functioning accumulator banks are monitored by monitoring the pressure in the tanks and used as an indicator of the subsea installation status and as an aid for predicting the need for service by extrapolating the development of a model calculating in the system.

### Motor Temperature Analysis

Normal operating temperature of motor is 50 C. Max limit for motor is 90 C, and there will be a shutdown at approximately 70 C. The motor is cooled by external cooling coils, but in subsea systems one potential problem is external growth. If that is the case, the coolers should be cleaned by ROV tool. Trending the temperature can thus give indications about growth, and planning of ROV operations can be done knowing the trend of the growth based on temperature measurements. The temperature measurements can be compensated for differences in pump speed.

### PVR—Performance Analysis

The pressure is 20 bar higher in the motor than in the pump to ensure that no production fluid is going into the motor, which means that any leaks will be only clean hydraulic oil leaking into the production fluid. If there is an error in the PVR, which controls the over-pressure, the motor pressure can be run manually from topside. This requires an ROV operation. Trending the overpressure therefore allows the operator to plan for the ROV operation for this purpose.

### Vibration Analysis

If radial and axial accelerometers is installed on each pump. Mean vibration parameters may be used in the analysis similar to above; that is mean velocity, acceleration, deviation. Vibration monitoring of rotating machinery in offshore and other industries is widely used and is recognized as a valuable tool for detecting faults and plan maintenance of such equipment. The overall vibration level can be used for trending and for RMS values such as acceleration or velocity.

To summarize the invention relates to a method and system for predicting time to service for subsea pumping systems based on:
one or more performance indicators
a plot or estimation of the performance indicator variation versus time
fitting of curve or indicator variation to data for extrapolating the variation and predicting future degradation
setting tolerance limit for performance indicator defining the conditions requiring maintenance, repair or replacement of equipment.
estimating time to service based on the time before the above-mentioned extrapolation reaches the tolerance limit.

As stated above the performance indicators may be one or more of the listed variables; lube oil consumption, pump efficiency and/or the number of accumulators in service, or a generated mathematical model based on typical developments of the variables over time and toward a breakdown or shutdown of the system.

Thus according to the invention an index is calculated, e.g. from a known value, and from how it develops in time a simple regression is used to predict when the index will reach a certain threshold value. This threshold value defines how which value the user will allow the index to reach before they perform maintenance on the system. This may be a limit in the allowed efficiency, and not necessarily failure.

The system does not involve an a priori model for the component lifetimes, as there is no way to make such models. The present system only extrapolates the development of chosen indices in time without the use of any statistical failure rate etc. This gives the possibility to change the model quickly as a reaction to sudden changes in the conditions and to make predictions without any predetermined model describing the system or its components.

1. A system for monitoring subsea equipment performance and for providing early warning for equipment maintenance, comprising:
at least one sensor coupled to said equipment and arranged to measure at least one performance indicator value; and
a calculation unit for sampling the measured indicator values at a chosen rate and from the sampled data estimating a likely future development of the sampled value and estimating the time for the passing of a chosen threshold value, the threshold value being a critical value requiring repair or replacements of said equipment, the system being adapted to provide a signal indicating the calculated time of repair/replacement, and wherein the monitored equipment is a subsea pump in a subsea pumping system and one of said at least one performance indicator values is the lube oil consumption.

2. The system according to claim 1, wherein the estimated future development is recalculated and corrected at certain intervals, so as to update the calculated time of repairs/replacement.

3. The system according to claim 1, wherein monitored equipment is a subsea pump in a subsea pumping system and the measured indicator value is the pump efficiency.

4. The system according to claim 1, wherein monitored equipment is a subsea pump in an accumulator bank in a subsea pumping system and one of said at least one performance indicator values is pressure in the accumulator tanks.

5. The system according to claim 1, wherein a number of performance indicators are measured, the calculation unit being adapted to construct a model based on the measurements and known characteristics of the development of each indicator and to estimate the repair/replacement time based on the model.

6. A method for monitoring subsea equipment performance and for providing early warning for equipment maintenance, comprising:
measuring at least one performance indicator at a chosen rate with at least one sensor coupled to said equipment and sampling the measured indicator values; and
estimating from the sampled data a likely future development of the sampled value and estimating the time for the passing of a chosen threshold value, the threshold value being a critical value requiring repair of replacements of said equipment;
wherein the monitored equipment is a subsea pump in a subsea pumping system and one of said at least one indicator value is the lube oil consumption.

7. The method according to claim 6, wherein the estimated future development is recalculated and corrected at certain intervals, so as to update the calculated time of repairs/replacement.

8. The method according to claim 6, wherein a measured indicator value is the pump efficiency.

9. The method according to claim 6, wherein a measured indicator value is pressure in the accumulator tanks.

10. The method according to claim 6, wherein a number of performance indicators are measured, the calculation unit being adapted to construct a model based on the measurements and known characteristics of the development of each indicator and to estimate the repair/replacement time based on the model.

11. A system for monitoring subsea equipment performance and for providing early warning for equipment maintenance, comprising:
at least one sensor coupled to said equipment and arranged to measure at least one performance indicator value; and
a calculation unit for sampling the measured indicator values at a chosen rate and from the sampled data estimating a likely future development of the sampled value and estimating the time for the passing of a chosen threshold value, the threshold value being a critical value requiring repair of replacements of said equipment, the system being adapted to provide a signal indicating the calculated time of repair/replacement, and wherein the monitored equipment is a subsea pump in an accumulator bank in a subsea pumping system and one of said at least one performance indicator values is pressure in the accumulator tanks.

12. The system according to claim 11, wherein the estimated future development is recalculated and corrected at certain intervals, so as to update the calculated time of repairs/replacement.

13. The system according to claim 11, wherein a measured indicator value is the lube oil consumption.

14. The system according to claim 11, wherein a measured indicator value is the pump efficiency.

15. The system according to claim 11, wherein a number of performance indicators are measured, the calculation unit being adapted to construct a model based on the measurements and known characteristics of the development of each indicator and to estimate the repair/replacement time based on the model.

16. A method for monitoring subsea equipment performance and for providing early warning for equipment maintenance, comprising:
measuring at least one performance indicator with at least one sensor coupled to said equipment at a chosen rate and sampling the measured indicator values; and
estimating from the sampled data a likely future development of the sampled value and estimating the time for the passing of a chosen threshold value, the threshold value being a critical value requiring repair of replacements of said equipment;
wherein the monitored equipment is a subsea pump in an accumulator bank in a subsea pumping system and one of said at least one indicator value is pressure in the accumulator tanks.

17. The method according to claim 16, wherein the estimated future development is recalculated and corrected at certain intervals, so as to update the calculated time of repairs/replacement.

18. The method according to claim 16, wherein a measured indicator value is the lube oil consumption.

19. The method according to claim 16, wherein a measured indicator value is the pump efficiency.

20. The method according to claim 16, wherein a number of performance indicators are measured, the calculation unit being adapted to construct a model based on the measurements and known characteristics of the development of each indicator and to estimate the repair/replacement time based on the model.
